(19) United States
(12) Patent Application Publication
(10) Pub. No.: US 2012/0115455 A1
(43) Pub. Date: May 10, 2012

(54) SECURE BOOTSTRAP PROVISIONING OF ELECTRONIC DEVICES IN CARRIER NETWORKS

(76) Inventor: Bindu Rama Rao, Laguna Niguel, CA (US)

(21) Appl. No.: 13/350,355

(22) Filed: Jan. 13, 2012

Related U.S. Application Data
(63) Continuation of application No. 10/899,513, filed on Jul. 26, 2004, now abandoned.

(51) Int. Cl. G06F 15/177; H04W 4/00

(52) U.S. Cl. 455/418; 713/2; 713/1

(57) ABSTRACT

Disclosed herein is a secure initial provisioning system for communicating data between an electronic device and a management server in a carrier network. The management server may be adapted to facilitate secure initialization provisioning or bootstrap provisioning. An initialization-provisioning table may be made available in the electronic device during manufacturing, or may also be provided in a SIM card. The initialization-provisioning table provides security information, such as keys, for example, and enables secure and spoof-proof push-based initial/bootstrap provisioning or bootstrap of electronic devices.

### CROSS-REFERENCE TO RELATED APPLICATIONS

This application is a continuation of U.S. patent application Ser. No. 10/899,513, filed on Jul. 26, 2004. The present application makes reference to, claims priority to, and the benefit of U.S. Provisional Patent Application 60/490,378 entitled “Secure Bootstrap Provisioning of a Mobile Handset in a Carrier Network”, filed Jul. 25, 2003, the complete subject matter of which is hereby incorporated herein by reference in its entirety.

The present application also hereby incorporates herein by reference in its entirety, the complete subject matter of PCT Application having publication number WO02/41147 A1 and PCT application number PCT/US01/44034, filed on Nov. 19, 2001.

The present application also hereby incorporates herein by reference in its entirety, the complete subject matter of U.S. Provisional Patent Application 60/249,606 filed on Nov. 17, 2000.

The present application also hereby incorporates herein by reference in its entirety, the complete subject matter of U.S. Provisional Patent Application 60/422,048, filed Oct. 29, 2002.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Electronic devices, such as mobile phones and personal digital assistants (PDA's), often contain firmware and application software that are either provided by the manufacturers of the electronic devices, by telecommunication carriers, or by third parties. There is a fundamental problem in communicating data such as firmware/software updates between mobile electronic devices and the management servers that provide such data.

In some carrier networks, provisioning of security parameters, configuration parameters, etc., occurs when a number assignment module (NAM) programming process is conducted. However, newer provisioning systems based upon a synchronization mark-up language (SyncML) device management technology, support over-the-air provisioning, wherein a server, such as a SyncML device management server, or a provisioning server associated with a SyncML device management server, for example, sends provisioning information to an electronic device. Such provisioning must be secure. However, it is often impossible to support secure communications in electronic devices that have not been provisioned. In this regard, provisioning information may be spoofed by unauthorized servers, cause security breaches, and make unauthorized access to the electronic devices more probable.

In some provisioning systems, such as the those based upon proposed open mobile alliance (OMA) device management approaches, provisioning may be a two-step process in which, during the first step, employing wireless application protocol (WAP) push or similar technologies, such as short message service (SMS) push, etc., initial provisioning is conducted.

The scope of initial provisioning is often restricted to provisioning an address, a universal resource locator (URL), or access parameters of a provisioning server or a device management server. Subsequently, during the second step, by employing SyncML device management or SyncML device service protocols, a full provisioning for a majority of configuration parameters, network parameters, security parameters, etc., is conducted with participation of the provisioning server or a device management server previously provisioned in the first step.

At least one major problem with the two-step provisioning task discussed above is the lack of security of initial provisioning during the first step of provisioning when the details of a provisioning server or a device management server is to be provisioned in an electronic device. This activity needs to be secure, but is not secure, and may be spoofed by unauthorized and/or illegal servers.

For example, push-based provisioning of the particulars (server identification, server URL, etc.) of a device management server or a provisioning server may be initiated by an unauthorized server and the server URL may refer to an unauthorized server, which, when accessed, may deliver unauthorized, defective, or even malicious provisioning information during the second step. Thus, the problem of making the initial push of provisioning information to the electronic device secure is very important.

Further limitations and disadvantages of conventional and traditional approaches will become apparent to one of ordinary skill in the art through comparison of such systems with the present invention as set forth in the remainder of the present application with reference to the drawings.

### SUMMARY OF THE INVENTION

Aspects of the present invention may be found in a method of bootstrap provisioning an electronic device in a carrier network. The method may comprise retrieving provisioning information associated with the electronic device and retrieving server identification information. The method may also comprise inserting the server identification information into the provisioning information and encrypting at least a portion of the provisioning information.

In an embodiment according to the present invention, encrypting at least a portion of the provisioning information may comprise encrypting the server identification information.

In an embodiment according to the present invention, the method may further comprise determining that an electronic device is present in the carrier network.

In an embodiment according to the present invention, the provisioning information may at least comprise a server ID and an encryption key associated with the server ID.

In an embodiment according to the present invention, the method may further comprise sending a provisioning message comprising provisioning information to the electronic device.

In an embodiment according to the present invention, the method may further comprise inserting an encryption key associated with the server identification information into the provisioning information.

Aspects of the present invention may be found in a method of bootstrap provisioning an electronic device in a carrier network. The method may comprise receiving provisioning information comprising at least a server ID portion and an encrypted portion. The encrypted portion may comprise an encrypted copy of the server ID portion. The method may also comprise accessing a key using the server ID portion and decrypting the encrypted portion using the key. The method may also comprise determining whether the received server ID portion matches the server ID portion from the decrypted portion.

In an embodiment according to the present invention, the method may further comprise creating a provisioning table for containing provisioning information.

In an embodiment according to the present invention, the method may further comprise retrieving an encryption key from the provisioning table.

In an embodiment according to the present invention, the method may further comprise deleting provisioning information contained in the provisioning table after provisioning has been completed.

In an embodiment according to the present invention, the method may further comprise accessing secondary provisioning information from at least one of a same and a different server from where initial provisioning information originated.

In an embodiment according to the present invention, accessing secondary provisioning information may comprise employing an address of a secondary server to facilitate further provisioning activities.

Aspects of the present invention may be found in a system for communicating provisioning information to electronic devices. The system may comprise a carrier network and a plurality of electronic devices adapted to be associated with the carrier network. The system may be adapted to facilitate secure communication of provisioning information between the carrier network and the plurality of electronic devices when the electronic devices are in an un-provisioned state.

In an embodiment according to the present invention, the carrier network may comprise at least one server adapted to conduct provisioning activities and provide provisioning information to the plurality of electronic devices.

In an embodiment according to the present invention, the plurality of electronic devices may comprise at least one client device adapted to communicate with the carrier network.

In an embodiment according to the present invention, secure communication between the carrier network and the plurality of electronic devices may be carried out via a communications link. The communications link may comprise at least one of a wire, a cable, an optical fiber, and a wireless connection.

In an embodiment according to the present invention, the plurality of electronic devices may comprise a plurality of mobile electronic devices having at least one of software and firmware. The plurality of mobile electronic devices may comprise at least one of mobile cellular phone handsets, personal digital assistants, pagers, MP3 players, and digital cameras.

In an embodiment according to the present invention, communicating provisioning information may comprise providing references to servers adapted to deploy provisioning information to the plurality of electronic devices.

In an embodiment according to the present invention, the references may be employed to initiate at least one of bootstrap provisioning and additional follow-up provisioning. The references may be employed to direct communication with one of a same and a different server for provisioning activities.

In an embodiment according to the present invention, the plurality of electronic devices may further comprise an identification submission mechanism and an identification reading mechanism.

In an embodiment according to the present invention, the identification submission mechanism and the identification reading mechanism may comprise one of a subscriber identity module (SIM) card and a SIM card reader, respectively.

In an embodiment according to the present invention, the SIM card may comprise a provisioning table. The provisioning table may at least comprise a server ID and an encryption key associated with the server ID.

In an embodiment according to the present invention, the plurality of electronic devices may be adapted to receive a provisioning message and to determine whether the message originated from an authorized server.

In an embodiment according to the present invention, the message may comprise one of a wireless application protocol (WAP) push notification from a WAP server and a short message service (SMS) message received from an SMS server in the carrier network.

In an embodiment according to the present invention, determining whether the message originated from an authorized server may comprise comparing a first server ID retrieved from provisioning information stored in the plurality of electronic devices to a second server ID supplied along with one of an SMS message and a WAP push notification from the carrier network.

These and other advantages, aspects, and novel features of the present invention, as well as details of illustrated embodiments thereof, will be more fully understood from the following description and drawings.

### BRIEF DESCRIPTION OF SEVERAL VIEWS OF THE DRAWINGS

FIG. 1A is a block diagram illustrating an exemplary provisioning system comprising a carrier network adapted to facilitate provisioning of an electronic device in a secure mode in accordance with an embodiment of the present invention;

FIG. 1B is a block diagram illustrating an exemplary secure provisioning system for communicating data between a management server and an electronic device in a carrier network in accordance with an embodiment of the present invention;

FIG. 2A illustrates an exemplary initialization-provisioning table employable in an electronic device in accordance with an embodiment of the present invention;

FIG. 2B illustrates an exemplary initialization-provisioning table that may be incorporated into a SIM card in accordance with an embodiment of the present invention;

FIG. 2C illustrates another exemplary initialization-provisioning table adapted to be incorporated into a SIM card in accordance with an embodiment of the present invention; and

FIG. 3 is a flow chart illustrating an exemplary bootstrap provisioning operation that may be conducted by a carrier network in accordance with an embodiment of the present invention.

### DETAILED DESCRIPTION OF THE INVENTION

Electronic devices may be adapted to access servers to retrieve provisioning data for provisioning electronic devices. An electronic device may be, for example, a mobile electronic device having software/firmware, such as, mobile cellular phone handsets, personal digital assistants (PDA's), pagers, MP3 players, digital cameras, etc. Provisioning data may comprise information that modifies or changes firmware or software installed in the electronic device, for example, initial bootstrap provisioning. Provisioning data may also add new services to the electronic device, as desired by a service provider, device manufacturer, or an end-user.

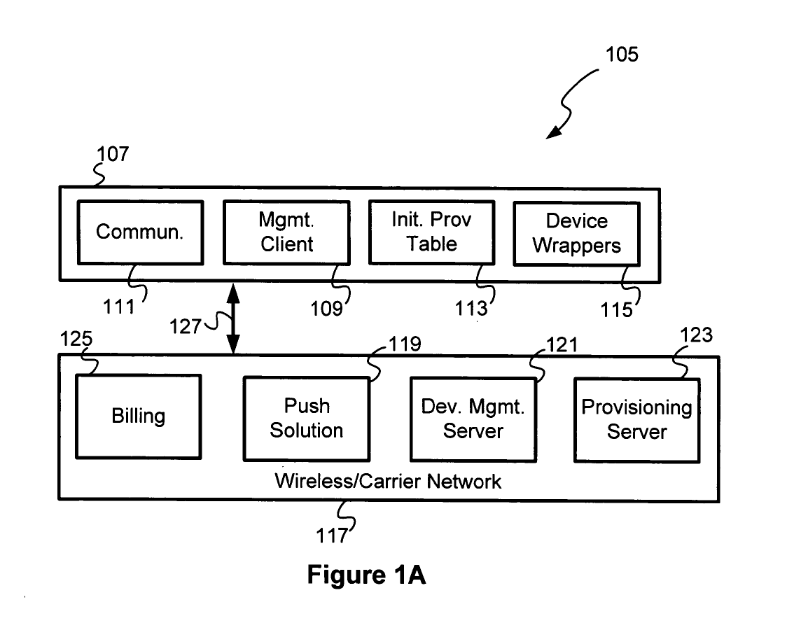

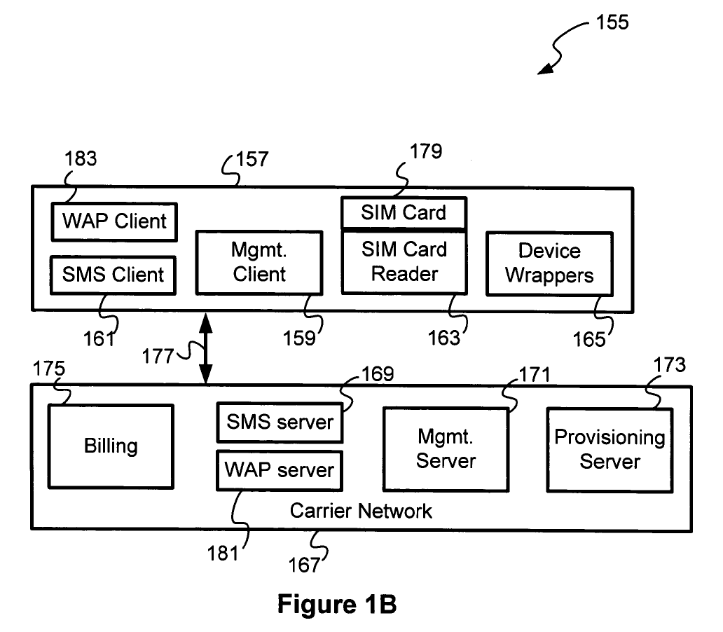

FIG. 1A is a block diagram illustrating an exemplary provisioning system 105 comprising a carrier network 117 adapted to facilitate provisioning of an electronic device, for example, mobile handset 107, in a secure mode in accordance with an embodiment of the present invention. FIG. 1A discloses an electronic device, for example, mobile handset 107, and a carrier network 117 (the carrier network 117 may be a wireless network, for example) adapted to facilitate provisioning of the electronic device, for example, mobile handset 107, in a secure mode.

The provisioning system 105 may also prohibit illegal and/or unauthorized provisioning of electronic devices, for example, mobile handset 107, by unauthorized servers within the wireless/carrier network 117 or from outside the wireless/carrier network 117. The wireless/carrier network 117 may comprise a device management (DM) server 121 capable of managing electronic devices, for example, mobile handset 107.

In an embodiment according to the present invention, the wireless/carrier network 117 may also comprise a push solution 119 (for example, a wireless application protocol (WAP) push, a short message service SMS push, etc.) capable of communicating notifications and/or provisioning data to electronic devices, for example, mobile handset 107. The wireless/carrier network 117 may also comprise a provisioning server 123 conducting provisioning activities and/or providing provisioning data to the DM server 121, and a billing server 125 facilitating various billing activities.

In an embodiment according to the present invention, the electronic device, for example, mobile handset 107, may be adapted to communicate with the wireless/carrier network 117 via communication link 127. Communication link 127 may comprise a wire, a cable, an optical fiber, or may be a wireless communication link.

The electronic device, for example, mobile handset 107, may be provisioned before a user can employ the electronic device to use the subscribed services.

The electronic device, for example, mobile handset 107, may comprise a communication module 111 adapted to facilitate communications and data transfers, and a management client 109 adapted to facilitate interaction with the DM server 121. The electronic device may also comprise initialization-provisioning table 113 containing information usable for determining whether the server (e.g., DM server 121 or provisioning server 123) performing provisioning on the electronic device is an authorized server. Device wrappers 115 may provide functionality to retrieve user information, subscription information, and device-related information from a non-volatile memory or a subscriber identity module (SIM) card of the electronic device, for example, mobile handset 107.

By employing initialization-provisioning table 113, the management client 109 may determine whether the provisioning information sent to the electronic device, for example, mobile handset 107, via a push notification, such as a WAP push or an SMS message, originated at a known authorized source, such as DM server 121, for example. If the push notification is determined to have originated from an unknown or unauthorized source, then the initial provisioning information may be discarded.

On the other hand, if the push notification with initial provisioning data, for example, the address of DM server 121, is determined to have originated from a known and/or authorized source, then the initial provisioning information supplied by the push notification may be retrieved, processed, and saved. For example, the URL of DM server 121, for example, may be copied to a provisioning section of non-volatile memory of the electronic device, for example, mobile handset 107.

The initialization-provisioning table 113 made available in the electronic device, for example, mobile handset 107, during manufacturing, or subsequently provided in a SIM card, may provide security information, such as keys to enable secure and spoof-proof push-based initial provisioning and/or bootstrap of the electronic device, for example, mobile handset 107.

In an embodiment according to the present invention, the DM server 121 may send a push notification via push solution 119 to the electronic device, for example, mobile handset 107. The push notification may contain initial provisioning information, for example, the address of DM server 121 or the address of another SyncML DM server capable of conducting further provisioning of the electronic device, for example, mobile handset 107. The push notification may comprise data such as, for example, the URL or Internet protocol (IP) address of DM server 121, the address of the source of the notification, and information identifying whether the information is encrypted using a private key of DM server 121. A corresponding public key is expected to be available in the electronic device, for example, mobile handset 107.

The push notification may also comprise server identification (ID) for the source of the notification, i.e., the ID of the DM server 121 or a provisioning server that initiated the push notification or where the notification originated. The server ID may uniquely identify the source of the notification. The management client 109 of the electronic device, for example, mobile handset 107, may be capable of determining whether the source of the notification is authorized to send the notification containing initial provisioning data. For example, the management client 109 may employ the server ID to retrieve a public key, employ the public key to decrypt encrypted push notification data, verify whether decryption was successful, (such as, for example, by comparing an embedded server ID or some other data to an ID sent along with the push notification), and selectively conduct initial provisioning of the electronic device, for example, mobile handset 107.

In an embodiment according to the present invention, the DM server 121 may send a push notification along with an unencrypted server ID as a portion of the contents of the notification. Other contents of the notification may comprise encrypted initial provisioning data, such as for example, the URL of the DM server 121 or the URL of a provisioning server. The management client 109 may employ the unencrypted server ID to retrieve the public key from the initialization-provisioning table 113 and may employ the public key to decrypt the encrypted components of the push notification. The push notification may initialize provisioning data in extensible mark-up language (XML) format, including the URL of a DM server to be used for further provisioning, and a server ID.

The management client 109 may compare the decrypted server ID, for example, the DM server URL or provisioning sever URL, to the unencrypted server ID to determine if the ID's match. If a match occurs, then the originating server may be authenticated, the validity of the initial provisioning data may be confirmed, and the provisioning data may be saved in non-volatile memory in the electronic device, for example, mobile handset 107. The initialization-provisioning table may be populated with tuples containing the server ID and public key information, for example. The table may comprise at least two columns, for example. The first column may be a server ID column employed as a reference to the second column. The second column may contain public keys associated with private keys of known management servers and/or provisioning servers possessing a corresponding server ID.

The electronic device manufacturer may populate the provisioning data into the initialization-provisioning table 113 in the electronic device, for example, mobile handset 107, during manufacture. The manufacturer may also enter the values of the server ID's and associated 128-byte public keys for DM servers from a plurality of wireless/carrier networks during the manufacturing process.

In an embodiment according to the present invention, the electronic device, for example, mobile handset 107 may be provisioned in two steps. The first step may comprise an initial/bootstrap-provisioning step performing a “minimum” provisioning. The second step may comprise a second or follow-up provisioning step wherein data associated with a plurality of subscribed services, configuration parameters, security parameters, etc., are provisioned.

The initial provisioning data may be provided by a push notification such as, for example, a WAP push or a SMS push resulting in provisioning reference information (for example, an IP address, a uniform resource name (URN), or a URL) being sent to the server responsible for follow-up provisioning. The first provisioning step may be made secure by encryption based upon a public key/private key pair corresponding to the server initiating the push notification, the data being encrypted by the private key, the initial provisioning data (also called bootstrap provisioning data) being decrypted using the public key, and the public key being retrieved from the initialization-provisioning table 113 using the server ID of the corresponding server. Other types of security mechanisms may also be used wherein the initialization-provisioning table 113 may be used to save a key and/or the server ID may be used to subsequently retrieve a key.

In an embodiment according to the present invention, the server ID along with encrypted push notification data may be sent along with a message, for example, in a header part of the message, or as part of an unencrypted message.

Having the server ID and the associated public key of a DM server or a provisioning server populated into the initialization-provisioning table 113 during manufacture of the electronic device may be considered pre-provisioning the electronic device. Pre-provisioning of information associated with, for example, wireless/carrier networks, etc., may make it possible to determine whether a first-time or initial/bootstrap provisioning may be conducted by authorized sources. Unauthorized provisioning, by unauthorized sources and hackers, is prevented. Hacking and/or spoofing attempted by illegal and/or unauthorized sources may be detected and prevented accordingly.

In an embodiment according to the present invention, the server ID may be, for example, an alphanumeric character string, a number, etc. Other mixed types of server ID's may also be used.

In an embodiment according to the present invention, a key associated with a server ID may be, for example, a 40-byte key, a 512-byte key, a 1024-byte key, etc. Other types of keys and keys having other/different lengths may also be employed.

In an embodiment according to the present invention, after initial provisioning or bootstrap provisioning of the electronic device, for example, mobile handset 107, the initialization-provisioning table 113, and/or the contents thereof, may be deleted to make room for additional data and/or code.

In an embodiment according to the present invention, after initial provisioning or bootstrap provisioning, initialization-provisioning table 113 entries for an associated server 1D, for example, a server ID and key associated with a server originating/initiating an initialization/bootstrap provisioning, may be retained in the initialization-provisioning table 113 while other entries may be deleted.

Although the initialization-provisioning table 113 as described herein is a table comprising a plurality of rows and columns, other data structures, for example, hash tables, lists, hash maps, etc., may also, or alternatively be used.

The initialization-provisioning table 113 may contain a public key associated with a DM server or a carrier network, for example. Other keys associated with a server ID may also be employed. For example, a shared key known to the electronic device, for example, mobile handset 107, and the carrier network or DM server 121 may be employed.

FIG. 1B is a block diagram illustrating an exemplary secure provisioning system 155 for communicating data between a management server 171 and an electronic device 157 in a carrier network 167 in accordance with an embodiment of the present invention.

In FIG. 1B, a secure provisioning system 155 for communicating data between a management server 171 in a carrier network 167 and an electronic device, for example, mobile handset 157 is disclosed. The secure provisioning system 155 may be adapted to facilitate secure communication of provisioning data/code between electronic devices, for example, mobile handset 157, and a carrier network 167, when an electronic device is “new” to the carrier network 167 or un-provisioned in accordance with the carrier network 167. The electronic device, for example, mobile handset 157 may comprise a management client 159, device wrappers 165, an SMS client 161, a WAP client 183, a SIM card reader 163, and a SIM card 179. The carrier network 167 may comprise a management server 171, a SMS server 169, a WAP server 181, a provisioning server 173, and a billing server 175. The electronic device 157 and the carrier network 167 may communicate via a communications link 177. The communications link 177 may be a wire, a cable, an optical fiber, or a wireless connection, for example.

The electronic device, for example, mobile handset 157, may be provisioned using the WAP client 183 or the SMS client 161 for initial/bootstrap provisioning during which references to management server 171 or provisioning server 173, for example, may be received and set-up. The references may be employed to initiate follow-up provisioning of the electronic device, for example, mobile handset 157, via, for example, a SyncML DM protocol-based provisioning between management client 159 and management server 171.

The SIM Card 179 may be used to provide an initialization-provisioning table, such as for example, the initialization-provisioning table 113 illustrated in FIG. 1A, to the electronic device, for example, mobile handset 157.

When inserted into the SIM card reader 163, the SIM card 179 containing the initialization-provisioning table 113 may provide server ID and public key data usable by the management client 159 to authenticate, for example, management server 171 and/or provisioning server 173, from which a bootstrap initialization message may originate. For example, authentication may comprise decrypting initial provisioning data supplied in an SMS message from the SMS server 169 or a WAP push notification from the WAP server 181 and comparing a first server ID retrieved from the decrypted provisioning data to a second server ID supplied (e.g., in a header or data field of a message) along with the SMS message or the WAP push notification.

In an embodiment according to the present invention, the SIM card/smart card 179 may provide security information, such as for example, the initialization-provisioning table 113 illustrated in FIG. 1A, to enable secure and spoof-proof, push-based, initial/bootstrap provisioning of the electronic device, for example, mobile handset 157.

In an embodiment according to the present invention, the server ID and the public key of management server 171 may be known to the electronic device, for example, mobile handset 157. An entry in the initialization-provisioning table 113 illustrated in FIG. 1A may exist for the management server 171, wherein the entry may have been populated during manufacturing or subsequently thereafter. Thus, initial/bootstrap provisioning messages and data encrypted with the management server's private key including an unencrypted server ID for management server 171 may be processed and installed by the electronic device, for example, mobile handset 157.

However, if some other server (an unauthorized server) tries to spoof/impersonate management server 171 and sends an unauthorized, bootstrap-provisioning message including provisioning data, even if the message employs the corresponding server ID of management server 171, the unauthorized sender will not be able to employ the private encryption key of management server 171. Therefore, any other key (unknown or unauthorized key) an unauthorized sender employs for encryption may not be decrypted by the public key retrieved from the initialization-provisioning table 113 illustrated in FIG. 1A, for example, (located in SIM card 179 or in the electronic device, for example, mobile handset 157), employing the server ID of management server 171 as an index or a reference. Thus, spoofing will not succeed and the electronic device, for example, mobile handset 157, may be able to detect and eliminate the spoofing information.

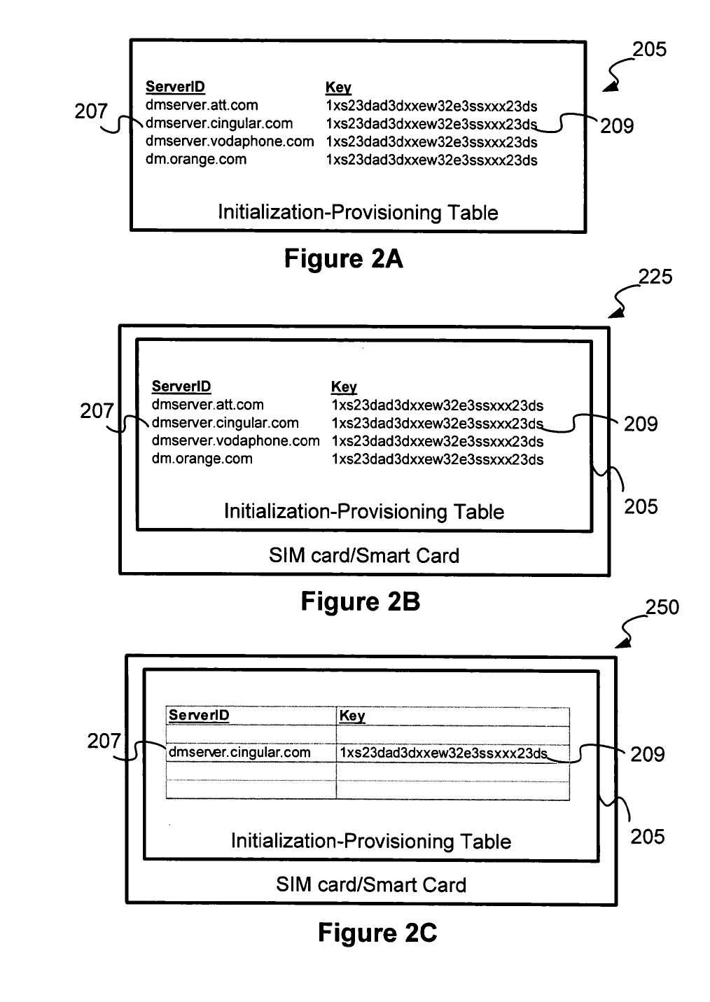

FIG. 2A illustrates an exemplary initialization-provisioning table 205 employable in an electronic device, for example, mobile handset 107 and/or 157, in accordance with an embodiment of the present invention. In FIG. 2A initialization-provisioning table 205 may be employed in an electronic device, for example, mobile handsets 107 and/or 157, to facilitate secure initial/bootstrap provisioning wherein spoofing or unauthorized provisioning attempted by an unauthorized management server or provisioning server may be identified and prohibited.

Initialization-provisioning table 205 may contain a plurality of rows illustrated generally in FIG. 2A. Each row may comprise a server ID such as, for example, server ID 207, and an associated key such as, for example, key 209, usable for security purposes. For example, the server ID 207 ‘dmserver.cingular.com’ illustrated in FIG. 2A, in the initialization-provisioning table 205 may have an associated exemplary key 209′ lxs23dad3dxxew32e3ssxxx23ds′ that may be used as a public key of a DM server such as, for example DM server 121 illustrated in FIG. 1A, identified by server ID 207.

In an embodiment according to the present invention, after bootstrap provisioning, wherein the electronic device, for example, mobile handset 107 and/or 157, is provisioned via WAP push notification or a SMS message, a set of provisioning information such as, for example, a URL or an address of a SyncML DM server (management server), network parameters, and/or configuration parameters, may be disposed in the electronic device (for example, in a management tree, not shown in the figures).

The provisioning information may be encrypted using a private key (not shown) of an originating server (i.e., a server originating bootstrap provisioning). Decryption is facilitated by a corresponding public key such as, for example, key 209 in the initialization-provisioning table 205 of the electronic device, for example, mobile handset 107 and/or 157, which may be retrieved using a server ID, for example, server ID 207, as an index, hash key, and/or a retrieval criteria.

FIG. 2B illustrates an exemplary initialization-provisioning table 205 that may be incorporated into a SIM card/smart card 225 in accordance with an embodiment of the present invention.

In FIG. 2B, the initialization-provisioning table 205 may be installed or incorporated into a SIM card/smart card 225 employed in an electronic device, for example, mobile handset 107 and/or 157, to facilitate secure initial/bootstrap provisioning of the electronic device and prohibit spoofing or unauthorized provisioning attempted by unauthorized management servers or provisioning servers. Each row of the initialization-provisioning table 205 may comprise a server ID, for example, server ID 207, and an associated key, for example, key 209, usable for security purposes. For example, the server ID 207 having a value of ‘dmserver.cingular.com’ illustrated in FIG. 2B, in the initialization-provisioning table 205 may, for example, have an associated exemplary key 209 having a value of ‘1xs23dad3dxxew32e3ssxxx23ds’ that may be used as a public key of a DM server, for example, DM server 121 illustrated in FIG. 1A, identified by server ID 207. Such a SIM card/smart card 225 may be provided by a carrier network, an electronic device manufacturer, and/or a vendor of a service provided to subscribers/owners of electronic devices. The SIM card/smart card 225 may be accessible by a management client, for example, management client 159, to authenticate an originating server sending a push-based bootstrap provisioning notification and associated encrypted data.

FIG. 2C illustrates another exemplary initialization-provisioning table 205 that may be incorporated into a SIM card 250 in accordance with an embodiment of the present invention.

82908090 21/30

In FIG. 2C, initialization-provisioning table 205 may contain one row to be installed or incorporated into a SIM card/smart card 250. Each row may comprise a server ID, for example, server ID 207, and an associated key, for example, key 209, usable for security purposes. For example, the server ID 207 having a value of ‘dmserver.cingular.com’ as illustrated in FIG. 2C, in the initialization-provisioning table 205 may have an associated exemplary key 209 having a value of ‘1xs23dad3dxxew32e3ssxxx23ds’ that may be used as a public key of a DM server such as, for example, DM server 121 as illustrated in FIG. 1A, identified by server ID 207.

The SIM card/smart card 250 may be employed in an electronic device to facilitate secure initial/bootstrap provisioning of the electronic device and to prohibit spoofing or unauthorized provisioning by unauthorized management servers or provisioning servers. A server ID 207 and an associated key 209 may be provided by a vendor issuing the SIM card/smart card 250, or alternatively by a carrier.

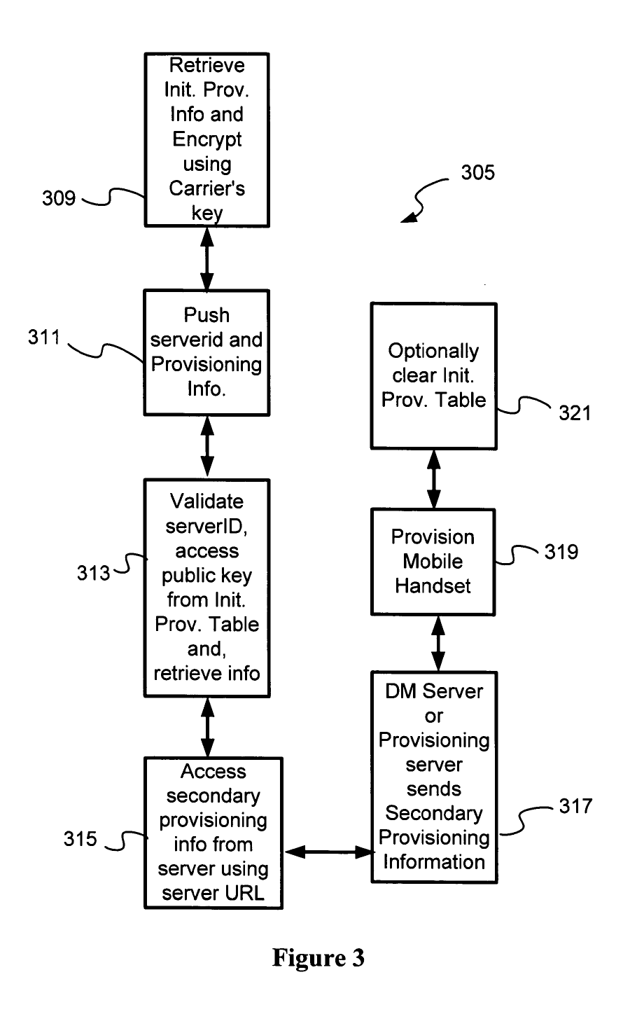

FIG. 3 is a flow chart illustrating an exemplary bootstrap provisioning operation 305 that may be conducted by a carrier network such as, for example, carrier network 117 and/or 167 illustrated in FIG. 1A and FIG. 1B, respectively, in accordance with an embodiment of the present invention.

In FIG. 3, processing may begin when a carrier network, for example, carrier network 117 and/or 167 illustrated in FIG. 1A and FIG. 1B, respectively, recognizes the presence of an electronic device, for example, electronic device 107 or 157 illustrated in FIG. 1A and FIG. 1B, respectively. The carrier network (117 or 167) may determine whether the electronic device (107 or 157) is to be provisioned. The device management server such as, for example, DM server 121 illustrated in FIG. 1A, may retrieve initialization-provisioning information associated with the electronic device, insert a server ID into the initialization-provisioning information in an initialization-provisioning table such as, for example, initialization table 113 as illustrated in FIG. 1A, determine a private key of a DM server 121, for example, and encrypt the initialization-provisioning information by employing the private key illustrated, as set forth in block 309 in FIG. 3.

In an embodiment according to the present invention, a key 209, for example, employable for encryption may be a key associated with a carrier network (117 or 167, for example) rather than a key associated with a DM server 121, for example. The DM server 121, for example, may send a push-based provisioning message to the electronic device, as set forth in block 311 in FIG. 3. The server ID 207, for example, may also be sent along with encrypted initialization-provisioning information. The server ID 207, for example, may be used to retrieve a public key from an initialization-provisioning table in the electronic device (107 or 157, for example).

The electronic device (107 or 157, for example) may receive the push-based provisioning message (e.g., via WAP push notification or a SMS message), recognize the message as a bootstrap provisioning message, validate the server ID 207, for example, by using the server ID 207 to access the public key associated with the server ID 207 from initialization-provisioning table 205, for example, decrypt initialization-provisioning information, and retrieve provisioning information, including the decrypted server ID 207, for example, as illustrated in block 313 in FIG. 3.

By comparing the retrieved server ID 207 with the ID sent unencrypted (for example, in a header or a data field of the message), the DM server 121, for example, from where the push notification message originated may be authenticated. Confirmation of a successful bootstrap provisioning may be sent from the electronic device (107 or 157, for example) to the DM server 121, for example, or the server from where the bootstrap provisioning message originated.

The electronic device (107 or 157, for example) may access secondary provisioning information from the DM server by employing a URL or an address of a secondary DM server adapted to facilitate further provisioning, wherein the address or the URL may have been provisioned during a previous bootstrap provisioning, as set forth in block 315 of FIG. 3. The secondary DM server may be the same as the server that initiated the initial bootstrap provisioning.

The DM server 121 or provisioning server 123, for example, may be adapted to send secondary provisioning information to the electronic device (107 or 157, for example), as set forth in block 317 of FIG. 3. For example, the DM server 121 may employ the SyncML DM protocol to conduct secondary provisioning or any additional follow-up provisioning. The electronic device (107 or 157, for example) may be provisioned with the received secondary provisioning information, as set forth in block 319 of FIG. 3. The rows comprising the server ID 207 and key tuples 209 in the initialization-provisioning table 205 may be deleted, as set forth in block 321 of FIG. 3.

In an embodiment according to the present invention, one or more rows of the initialization-provisioning table 205 associated with the carrier network may be retained while other rows may be deleted. Deleting rows frees up space occupied by extra, and often unnecessary, information in the initialization-provisioning table 205, for example.

Although a system and method according to the present invention has been described in connection with the preferred embodiment, it is not intended to be limited to the specific form set forth herein, but on the contrary, it is intended to cover such alternatives, modifications, and equivalents, as can be reasonably included within the spirit and scope of the invention as defined by this disclosure and the appended diagrams. It is intended that the scope of the invention be limited not with this detailed description, but rather by the claims appended hereto.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method of bootstrap provisioning an electronic device in a carrier network, the method comprising:
using an initialization-provisioning table, having source IDs and associated keys, stored in the electronic device to determine whether a received provisioning notification and a received initial set of provisioning data originated from a known and/or authorized source;
discarding the initial set of provisioning data if it is determined that the provisioning notification originated from an unknown and/or unauthorized source;
if it is determined that the provisioning notification originated from a known and/or authorized source, using an associated key from the initialization-provisioning table to receive, process and save the initial set of provisioning data to the electronic device; and
using the received, processed and saved initial set of provisioning data on the electronic device to access and retrieve complete provisioning data from the source.

2. The method according to claim 1, wherein the method includes receiving source server identification information from the initial set of provisioning data and, the source server identification information being encrypted in the initial set of provisioning data.

3. The method according to claim 1, further comprising determining that an electronic device is present in the carrier network.

4. The method according to claim 1, further comprising inserting an encryption key associated with source server identification information into the initial set of provisioning data.

5. A method of bootstrap provisioning an electronic device in a carrier network, the method comprising:
using an initialization-provisioning table, having source IDs and associated keys, stored in the electronic device to determine whether a received provisioning notification and a received initial set of provisioning data originated from a known and/or authorized source, the received initial set of provisioning data comprising at least a server ID portion and an encrypted portion, the encrypted portion comprising an encrypted copy of the server ID portion;
accessing a key from the initialization-provisioning table, using the server ID portion, and decrypting the encrypted portion using the key;
determining whether the received server ID portion matches the server ID portion from the decrypted encrypted portion.

6. The method according to claim 5, wherein, if it is determined that the received server ID portion matches the server ID portion from the decrypted encrypted portion, the method further comprising:
receiving, processing and saving the initial set of provisioning data to the electronic device; and
using the received, processed and saved initial set of provisioning data on the electronic device to access and retrieve complete provisioning data from the source.

7. The method according to claim 6, the method further comprising discarding the initial set of provisioning data if it is determined that the received server ID portion does not match the server ID portion from the decrypted encrypted portion;

8. The method according to claim 6, further comprising deleting provisioning information contained in a initialization-provisioning table after provisioning has been completed.

9. The method according to claim 6, wherein, if it is determined that the received server ID portion matches the server ID portion from the decrypted encrypted portion, the method further comprising accessing secondary provisioning information from one of a same and a different server from where the initial set of provisioning data originated.

10. The method according to claim 9, wherein accessing secondary provisioning information comprises employing an address of a secondary server to facilitate further provisioning activities.

11. A system for communicating provisioning information to electronic devices, the system comprising:
a plurality of electronic devices associated with a carrier network, wherein the plurality of electronic devices have access to an initialization-provisioning table having source IDs and associated keys, wherein the plurality of electronic devices include at least one of software and firmware to:
determine whether a received provisioning notification and a received initial set of provisioning data originated from a known and/or authorized source;
discard the initial set of provisioning data if it is determined that the provisioning notification originated from an unknown and/or unauthorized source;
if it is determined that the provisioning notification originated from a known and/or authorized source, use an associated key from the initialization-provisioning table to receive, process and save the initial set of provisioning data to the electronic device; and
use the received, processed and saved initial set of provisioning data on the electronic device to access and retrieve complete provisioning data from the source.

12. The system according to claim 11, wherein the carrier network comprises at least one server adapted to conduct provisioning activities and provide the initial set of provisioning data to the plurality of electronic devices.

13. The system according to claim 11, wherein the initial set of provisioning data comprises information providing references to servers adapted to deploy complete provisioning data to the plurality of electronic devices.

14. The system according to claim 11, wherein the plurality of electronic devices further comprises an identification submission mechanism and an identification reading mechanism wherein the identification submission mechanism and the identification reading mechanism comprise one of a subscriber identity module (SIM) card and a SIM card reader, respectively.

15. The system according to claim 14, wherein the SIM card comprises the initialization-provisioning table, the initialization-provisioning table at least comprising a server ID and a key associated with the server ID.

16. The system according to claim 15, wherein:
the received provisioning notification includes at least a server ID portion and an encrypted portion, the encrypted portion comprising an encrypted copy of the server ID portion; and
wherein the plurality of electronic devices are adapted to:
use the server ID portion to access the key from the initialization-provisioning table;
use the key to decrypt the encrypted portion using the key; and
determine whether the received server ID portion matches the server ID portion from the decrypted encrypted portion.
